(19) United States
(12) Patent Application Publication
(10) Pub. No.: US 2016/0055765 A1
(43) Pub. Date: Feb. 25, 2016

(54) INSTRUMENT TABLE PLACEMENT

(71) Applicant: Zimmer, Inc., Warsaw, IN (US)

(72) Inventor: Matthew E. Monaghan, Fort Wayne, IN (US)

(21) Appl. No.: 14/462,988

(22) Filed: Aug. 19, 2014

(51) Int. Cl. G09B 19/24

(52) U.S. Cl. CPC G09B 19/24

(57) ABSTRACT

An apparatus including a table cover configured to be placed over a surgical table; and the table cover including a plurality of symbols indicating a proper way to organize and use a plurality of surgical instruments.

### FIELD

The present subject matter relates to a surgery aide and specifically to an instrument table cover.

### BACKGROUND

Surgical procedures are complex and require many specialized instruments. Medical specialists, like surgeons, are primarily responsible for the principal objective of the procedures. However, they are nearly always assisted by others. In some circumstances, these other individuals represent collateral specialties in the procedure (e.g. anesthesia, vascular surgery). Others are assistants charged with supporting the primary care specialist in conducting the procedures (e.g. surgical assistant, scrub nurse).

Instruments vary with many factors such as the specific medical procedure, patient factors, surgeon's preference, or the implants or other devices they are intended to accompany. At the same time, surgical staff may have varying degrees of familiarity with the procedure or with the preferences of conducting the procedure of the attending physician or other specialists. Some staff circulate among many procedures and cannot become familiar with or recall familiarity of the many procedures they encounter. Some staff are new and may be learning how to support a procedure. In some instances, staff may perform their roles too infrequently to remember or be efficient about the use of instruments in the procedure.

All of these factors and others may lead to the misuse or mishandling of instruments. The mishandling of surgical instruments, errors in the sequence of instrument use, and inappropriate use of the surgical instruments may lead to surgical delays, contamination or increased risk of infection or other communicable disease, hazard to the physician or clinical staff, or harm to the patient. Therefore, it is important for instrument users to reliably understand the appropriate use of the instruments in a surgical procedure.

U.S. Pat. No. 8,511,468 and U.S. Publication 2006/0076254 show examples of devices to hold surgical instruments for surgery.

### OVERVIEW

In a first example, an apparatus can include a table cover configured to be placed over a surgical table, and the table cover including a plurality of symbols indicating a proper way to organize and use a plurality of surgical instruments.

In example 2, the plurality of symbols of example 1 can include outlines of the plurality of surgical instruments arranged in order of use during a medical procedure.

In example 3, the outlines of the plurality of surgical instruments in example 2 can be oriented such that a proper handling end of a given surgical instrument is facing the user.

In example 4, the plurality of symbols in example 1 can include numbers ordered to indicate the proper sequence of use of the plurality of surgical instruments.

In example 5, the plurality of symbols in example 1 can provide handling instructions for the plurality of surgical instruments.

In example 6, the plurality of symbols for providing handling instructions in example 5 can include outlines of the plurality of surgical instruments and the diagrams can be oriented so the proper end of a given surgical instrument is facing the user.

In example 7, the plurality of symbols in example 1 can include words describing the plurality of surgical instruments, the words being arranged in order of use of the surgical instruments during a medical procedure.

In example 8, the plurality of symbols in example 1 can provide cleaning instructions for the plurality of surgical instruments.

These examples can be combined in any permutation or combination. This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a perspective view of a surgical table with a table cover in accordance with one embodiment.

FIG. 2 shows a top view of the table cover of FIG. 1, in accordance with one embodiment.

### DETAILED DESCRIPTION

In a typical operating room, there is a table on which the patient is positioned. At the superior end is often the anesthesiologist. The surgeon can be near the wound site or near a remote operator console (e.g. during a robotic procedure). The physician's assistant or scrub nurse can be stationed elsewhere proximal to a surgical table positioned near tables of instruments.

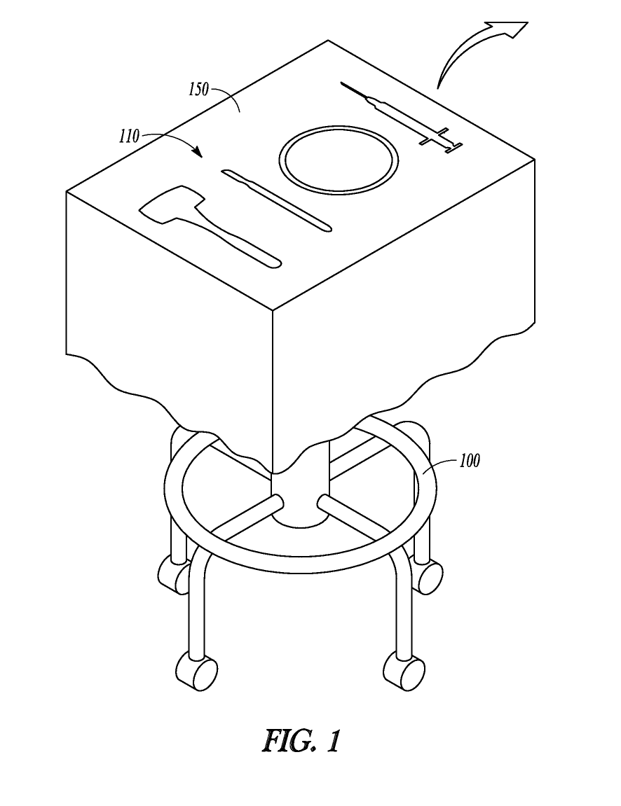

FIG. 1 shows a perspective view of a surgical table 100 with a table cover 150 in accordance with one embodiment.

In some cases, the surgical table 100 can be a plain rectangular table (e.g. a Mayo stand), dedicated for the storing, ordering, sorting, cleaning, assembling, disassembling, inspecting or use of instruments. Because of the space constraints, typical tables 100 are often small and require the dense organization of a plurality of surgical instruments 110 to keep them accessible, in sight and sterile. Risks of disorganization include improper use, contamination from dropping a surgical instrument onto an unsterile floor, damage of the surgical instruments 110 (breakage from drops and dulling from forms of contact), inefficient use of the surgical instruments 110 from excess handling sorting, searching, or manipulating so the instruments can be properly handed to the surgeon.

To reduce risks and overcome the challenges of this problem, the present system seeks to organize the plurality of surgical instruments 110 for a given procedure. In various embodiments, the system can inform the user of proper use, including sequence, handling instructions, gripping procedures, cleaning, and good organizing techniques. In some cases, this information can be important to a procedure, in cases where speed and efficiency are essential (e.g. critical trauma, where patients may have communicable disease, where outcomes are dependent on precise sequence of instruments or where errors may lead to risk or harm).

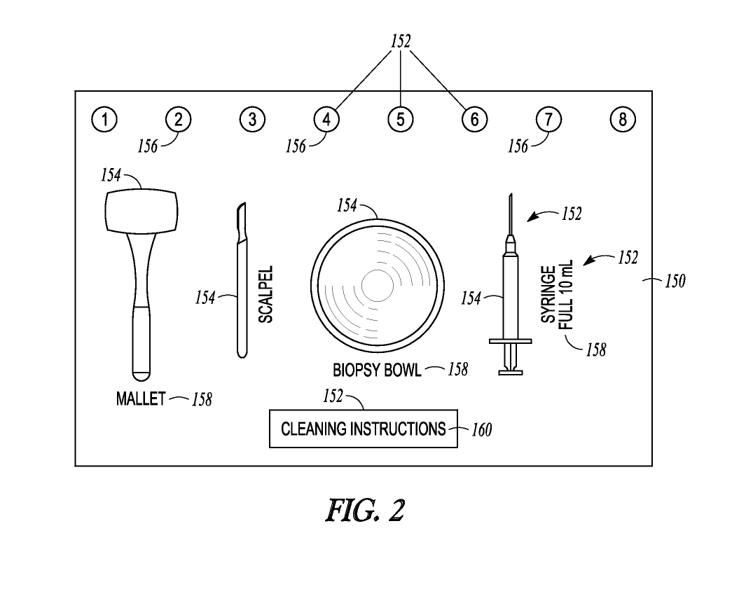

FIG. 2 shows a top view of the table cover 150, in accordance with one embodiment. Table cover 150 can be a sterile table cover configured to be placed over the surgical table 100. The table cover 150 can include symbols 152 which are presented showing an organized sequence of surgical instrument placement. In various examples, the table cover 150 can show the sequence in which instruments are used, and how instruments should be held so the handoff to the surgeon/user does not cause contamination or unwanted contact with sharp surfaces.

The cover 150 and symbols 152 and instructions may be customized for any particular procedure, or further organized based on factors such as patient type, patient conditions, surgeon preference, implant type, anatomic site.

In one example, the table cover 150 can include a plurality of the symbols 152 indicating a proper way to organize and use a plurality of surgical instruments. For example, the plurality of symbols 152 can include outlines 154 of the plurality of surgical instruments, with the outlines 154 being arranged in order of use during a medical procedure. The outlines 154 of the surgical instruments can be drawn or printed or otherwise formed on the table cover 150. The outlines 154 can be solid lines, dashed lines or other visual representation of the shape of the instrument.

In an example, the outlines 154 of the plurality of surgical instruments are oriented such that a proper handling end of a given surgical instrument is facing the user. This orientation of the outlines 154 can provide handling instructions for the plurality of surgical instruments. This allows the surgical aide to know which way to properly hand off the instrument to the surgeon, or allows the surgeon to properly take the instrument up themselves without wasting time re-orienting the instrument.

In an example, the plurality of symbols 152 can include numbers 156 ordered to indicate the proper sequence of use of the plurality of surgical instruments.

In an example, the plurality of symbols 152 can include words 158 describing the plurality of surgical instruments, the words 158 being arranged in order of use of the surgical instruments during a medical procedure. In an example, the words 158 can be placed proximate to the outline 154 of the corresponding instrument. Providing words 158 in addition to the outlines 154 can allow a surgical aide unfamiliar with a procedure to ascertain quickly which instrument the surgeon is requesting during a procedure.

In an example, the plurality of symbols 152 can include cleaning instructions 160 for one or more of the plurality of surgical instruments. Cleaning instructions 160 can include information such as whether an instrument should be discarded or sterilized, for example.

These various examples can be combined in different manners, with some embodiments omitting one or more of the types of the symbols 152 discussed. Other examples can utilize most or all of the symbols 152. For example, one embodiment can include the table cover 150 having the outlines 154 of the plurality of surgical instruments arranged in order of use during a medical procedure, wherein the outlines of the plurality of surgical instruments are oriented such that a proper handling end of a given surgical instrument is facing the user, and wherein the plurality of symbols 152 includes the numbers 156 ordered to indicate the proper sequence of use of the plurality of surgical instruments, and wherein the plurality of symbols 152 includes the words 158 describing the plurality of surgical instruments, the words being arranged in order of use of the surgical instruments during the medical procedure.

A few non-limiting examples of the use of the table cover 150 include organizing the instruments for a total hip replacement to enable the efficient and repeatable procedure, day-surgery, where the patient is intended to go home immediately afterwards without overnight admission, a clinical trial, where very repeatable use must be ensured, and to improve medial safety to prevent mishandling of instruments including injury to medical personnel or patient.

In use, the table cover 150 is provided with symbols 152 appropriate for a specific procedure to be performed. The method can include organizing a plurality of surgical instruments according to the plurality of symbols 152 on the surgical table cover 150, and using the surgical instruments during a medical procedure in the order in which the medical instruments were organized on the table cover 150.

As discussed, the example cover 150 disclosed herein is an example and does limit the present system. Accordingly, various permutations and combinations of surgical instruments can be used with the same technique. The cover 150 and symbols 152 and instructions may be customized for any particular procedure, or further organized based on factors such as patient type, patient conditions, surgeon preference, implant type, anatomic site.

Many different surgical instruments can be represented on the table cover 150 including, without limitation, mallets, scalpels, biopsy bowls, syringes, clamps of various sizes, scissors, saws, forceps, and implants themselves.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The claimed invention is:

1. An apparatus comprising:
a table cover configured to be placed over a surgical table; and
the table cover including a plurality of symbols indicating a proper way to organize and use a plurality of surgical instruments.

2. The apparatus of claim 1, wherein the plurality of symbols includes outlines of the plurality of surgical instruments arranged in order of use during a medical procedure.

3. The apparatus of claim 2, wherein the outlines of the plurality of surgical instruments are oriented such that a proper handling end of a given surgical instrument is facing the user.

4. The apparatus of claim 1, wherein the plurality of symbols includes numbers ordered to indicate the proper sequence of use of the plurality of surgical instruments.

5. The apparatus of claim 1, wherein the plurality of symbols provides handling instructions for the plurality of surgical instruments.

6. The apparatus of claim 5, wherein the plurality of symbols for providing handling instructions includes outlines of the plurality of surgical instruments and the diagrams are oriented so the proper end of a given surgical instrument is facing the user.

7. The apparatus of claim 1, wherein the plurality of symbols includes words describing the plurality of surgical instruments, the words being arranged in order of use of the surgical instruments during a medical procedure.

8. The apparatus of claim 1, wherein the plurality of symbols provides cleaning instructions for the plurality of surgical instruments.

9. The apparatus of claim 1, wherein the plurality of symbols includes outlines of the plurality of surgical instruments arranged in order of use during a medical procedure, wherein the outlines of the plurality of surgical instruments are oriented such that a proper handling end of a given surgical instrument is facing the user, and wherein the plurality of symbols includes numbers ordered to indicate the proper sequence of use of the plurality of surgical instruments, and wherein the plurality of symbols includes words describing the plurality of surgical instruments, the words being arranged in order of use of the surgical instruments during a medical procedure.

10. An apparatus comprising:
a table cover configured to be placed over a surgical table;
means for organizing a plurality of surgical instruments on the table cover; and
means for informing a user of a proper use of the plurality of surgical instruments.

11. The apparatus of claim 10, wherein the means for organizing includes a plurality outlines of the plurality of surgical instruments arranged in order of use during a medical procedure, and the means for informing the user includes orienting the outlines of the plurality of surgical instruments such that a proper handling end of a given surgical instrument is facing the user.

12. The apparatus of claim 10, wherein the means for informing the user includes numbers on the table cover ordered to indicate the proper sequence of use of the plurality of surgical instruments.

13. The apparatus of claim 10, wherein the means for organizing includes words describing the plurality of surgical instruments, the words being arranged in order of use of the surgical instruments during a medical procedure.

14. The apparatus of claim 10, further comprising placing instructions for cleaning the plurality of surgical instrument on the table cover.

15. The apparatus of claim 10, wherein the means for organizing includes a plurality of symbols including outlines of the plurality of surgical instruments arranged in order of use during a medical procedure and comprises a plurality of words describing the plurality of surgical instruments, the words being arranged in order of use of the surgical instruments during the medical procedure, wherein the means for informing a user includes the outlines of the plurality of surgical instruments being oriented such that a proper handling end of a given surgical instrument is facing the user, and a further comprising a plurality of numbers ordered to indicate the proper sequence of use of the plurality of surgical instruments.

16. The apparatus of claim 15, further comprising placing instructions for cleaning the plurality of surgical instrument on the table cover.

17. A method comprising:
organizing a plurality of surgical instruments according to a plurality of symbols on a surgical table cover; and
using the surgical instruments during a medical procedure in the order in which the medical instruments were organized.

18. The method of claim 17, wherein the plurality of symbols includes outlines of the plurality of surgical instruments arranged in order of use during a medical procedure.

19. The method of claim 18, wherein the outlines of the plurality of surgical instruments are oriented such that a proper handling end of a given surgical instrument is facing the user.

20. The method of claim 17, wherein the plurality of symbols includes numbers ordered to indicate the proper sequence of use of the plurality of surgical instruments.
